(19) United States
(12) Patent Application Publication
(10) Pub. No.: US 2003/0099229 A1
(43) Pub. Date: May 29, 2003

(54) Electrical device

(76) Inventors: Albert Tretter, Schirmitz (DE); Karl Weber, Altdorf (DE)

Correspondence Address: STAAS & HALSEY LLP, 700 11TH STREET, NW, SUITE 500, WASHINGTON, DC, 20001, US

(21) Appl. No.: 10/204,051

(22) PCT Filed: Jan. 30, 2001
(86) PCT No.: PCT/DE01/00354

(30) Foreign Application Priority Data
Feb. 18, 2000 (DE) 10007597.5

(51) Int. Cl. H04L 12/50; H04L 12/56

(52) U.S. Cl. 370/364; 370/401

(57) ABSTRACT

The invention relates to an electrical device (LNK) which has means (DP-S, K′) for forming a communication connection to a field bus (DP) and additional means (PA-M, FF-M, K) for forming a communication connection to an additional field bus (PAFF). Said device is thus presented as a combination of three communication stations (DP-S, PA-M, FF-M) for the respective connection to a field bus (DP, PA, FF).

The present invention relates to an electrical device for electrical and communicative connection of two bus systems.

Electrical devices of this type are generally known e.g. as “gateways”.

A bi-directional bus adapter is known from U.S. Pat. No. 5,191,653 A, which connects a system bus to an IO bus, whereby the system bus uses a first protocol and the IO bus uses a second protocol, whereby a data transfer is possible between devices on both sides of the bus adapter.

An electrical system is known from U.S. Pat. No. 5,177,737 A, in which a multi-purpose bus is used which interconnects various plug-in cards which make up the electrical system. Communication between the plug-in cards is realized via the bus, whereby access to the bus is divided up into different time intervals for this purpose. Different protocols can be used here.

The object of the electrical device according to the invention is to physically connect a first bus system to a second bus system, on which at least two different bus protocols can be used, in such a way that communication originating from a communications component connected to the first bus system is possible with any communications component connected to the second bus system, regardless of the bus protocol with which the communications component connected to the second bus system can be addressed.

This object is achieved with an electrical device according to claim 1.

The embodiment provides a summarized description of a possibility for the coexistence of profibus PA (PA=Process Automation) and FF (FF=Fieldbus Foundation) devices on one line.

The introduction of field buses in the process industry has been speeded up by the availability of components for PROFIBUS-PA. PROFIBUS-PA is based on the PROFIBUS-DP technology which is already widespread throughout the manufacturing industry, with the difference that a special, intrinsically safe transmission technology according to IEC 1158-2 is used in PA.

Along with PROFIBUS-PA, which is dominant primarily in Europe, Fieldbus Foundation (FF) technology is becoming increasingly important in the USA.

Providers of process control systems wish to/must offer their products not only on the European but also on the American market. This then causes the problem that providers have to deal with both technologies in order to be able to connect both PA and FF components to their management and control systems.

Siemens AG already offers a product line for the “PA domain” which, on the one hand, combines the intrinsically safe PROFIBUS-PA domain with the standard PROFIBUS-DP variant, thereby implementing networking within a process engineering system using one bus system. This involves the use of the PA segment coupler, which connects the intrinsically safe bus segments to the standard PROFIBUS physical connection (RS485 physical).

A further, specially developed component, the PROFIBUS-PA Link, can be used as a data concentrator or proxy to connect a plurality of intrinsically safe PA lines, which are fitted with PA components such as temperature or pressure measuring transducers, to the higher-order standard PROFIBUS network. The benefit gained is that, as far as transmission speed is concerned, the different segments can be separated by the PA link, since PROFIBUS-PA is specified with a baud rate of 31.25 kbaud, whereas PROFIBUS-DP supports baud rates in the 9.6 kbaud to 12 Mbaud range.

As far as the physical bus layer (Layer 1) is concerned, the Fieldbus Foundation (FF) bus is based on the IEC 1158-2 standard. This means that field devices of both domains (PA and FF) can be connected to the same transmission system. The two field buses differ only as from Layer 2 according to the ISO/OSI Layer Model.

However, this means that, in systems in which components from both domains are intended/have to be used, “separate” bus lines and connecting units are required.

An intelligent link is therefore intended to enable both PA slaves and FF slaves to be connected to the higher-order management system by means of PROFIBUS-DP via a common line.

The present invention is based on the principle that the two different Layer 2 protocols are not run simultaneously, but are processed alternately using a time-slice method, whereby the dynamic requirements of the slaves must not be violated in terms of their time monitoring.

At a specific time, the PROFIBUS protocol is therefore active and the PROFIBUS slaves are processed, whereafter the FF slaves are processed in a corresponding FF protocol time slice.

Further features, advantages and possible applications of the invention are indicated in the subclaims, the following description of an embodiment, with reference to figures, and the figures themselves. All the features described and/or graphically represented, either alone or in any given combination, form the subject matter of the present invention, regardless of their summarization in the claims or their back-reference.

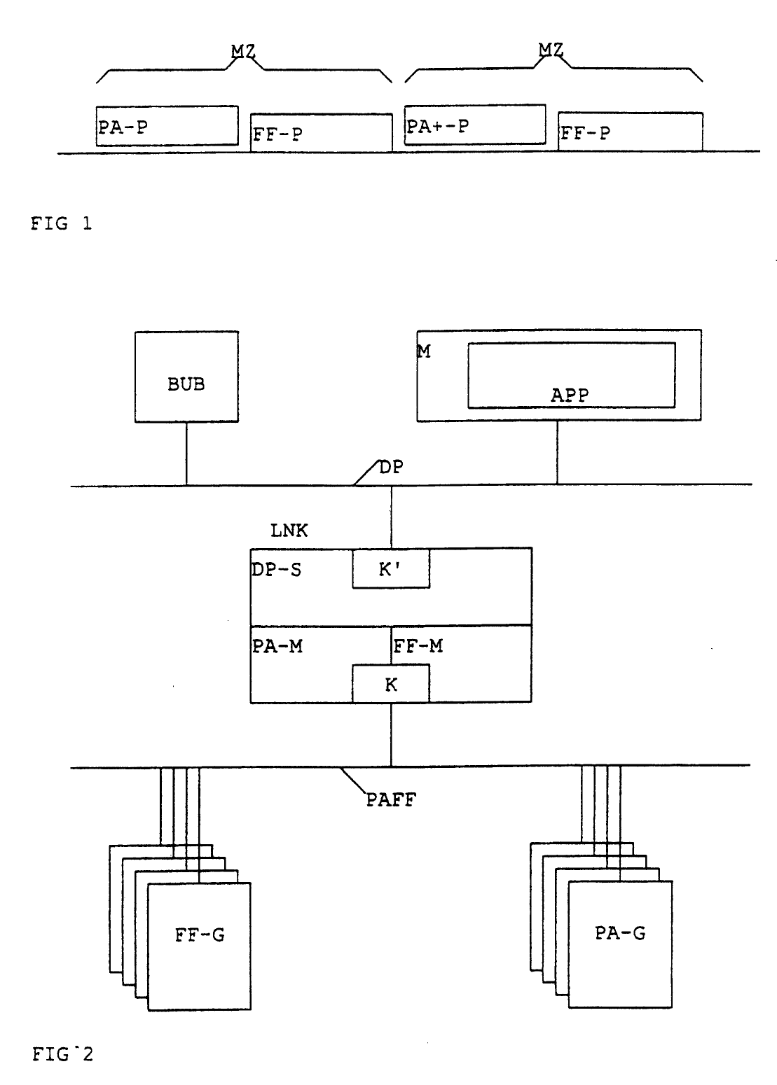

FIG. 1 shows the time slices of the two different protocols (Profibus and FF) and FIG. 2 shows a schematic overview of a system with a PA/FF link.

The implementation of the link LNK according to the invention requires the compatibility of the different protocols PA-P, FF-P, or messages on the common line PAFF.

This compatibility was investigated by means of an initially theoretical examination, with the result that the messages of the 2 protocols can be reliably distinguished using the specific character strings.

It is also ensured that the field devices of the relevant “inactive” protocol suffer no interference from the “active” protocol or do not switch to an error status.

Every communications standard stipulates that messages which do not correspond to the relevant protocol are to be declared as errored and are therefore to be rejected.

The temporal sequence of the two protocols on the bus is shown in FIG. 1.

In a first and a second macrocycle MZ shown in FIG. 1, all Profibus users PA-G are in each case initially addressed by means of the Profibus protocol PA-P and all FF users FF-G are then addressed by means of the FF protocol FF-P.

According to FIG. 2, the link LNK comprises at least one DP slave DP-S, a PA master PA-M and an FF-master FF-AM. NB: the link LNK and the electrical device LNK are used synonymously.

In alternative designs, it can of course also be provided that the link LNK has not only two masters PA-M, FF-M, but also a multiplicity of masters, each of which has its own communications protocol.

PA masters PA-M and FF masters FF-M access the PA/FF bus PAFF, to which PA devices PA-G and FF devices are connected, via a common communications interface K. The PA devices PA-G and the FF devices provide facilities for the connection of components of a technical process (not shown) which is to be controlled and/or monitored.

The DP slave DP-S accesses the DP bus DP via a dedicated communications interface K′ or can be addressed via this communications interface K′ by a master M. A device BUB is connected to the DP bus DP to operate and monitor the technical process. Furthermore, the DP master M, which has a memory in which an application program APP, the application APP, is stored, according to which the technical process is controlled and/or monitored, is connected to the DP bus DP.

The devices FF-G, PA-G, BUB, M shown in FIG. 2 in each case have their own interfaces (not shown), which enable the physical connection to the relevant bus PAFF, DP; an interface of this type of course in each case contains means for identifying and interpreting the messages transmitted in each case via the bus PAFF, DP.

Following a macrocycle MZ, all the components FF-G, PA-G located on the bus PAFF are addressed at least once. The retrieved user data are bundled by the link LNK and transmitted in a common collective message to the DP master M.

Furthermore, the slow, intrinsically safe bus segments and the fast PROFIBUS DP at up to 12 Mbaud are separated by the PA/FF link LNK.

With this link LNK, the process engineering user thus has the facility to connect measuring transducers from both protocol domains to his system.

This is particularly important if, for specific measuring methods for which no measuring transducers with a PROFIBUS-PA interface exist, a corresponding measuring transducer with an FF interface is available and is to be used.

The present invention can therefore also be presented as follows:

An electrical device LNK is indicated, which has means DP-S, K′ for a communications connection to a field bus DP, and further means PA-M, FF-M, K for a communications connection to a further field bus PAFF. These means are, on the one hand, the interfaces K, K′ themselves, and, on the other hand, the respective “communications components” DP-S, PA-M, FF-M.

The electrical device according to the invention therefore also presents itself as a combination of (at least) three communications components DP-S, PA-M, FF-M for the respective connection to a field bus DP, PA, FF, whereby a communications component DP-S, PA-M, FF-M on a field bus DP, PA, FF becomes the communications component DP-S, PA-M, FF-M in that, on the one hand, it is able to identify the transmission protocol DP-P, PA-P, FF-P defined for the field bus DP, PA, FF and therefore to receive messages (data) via the field bus DP, PA, FF and, on the other hand, it is able to send messages (data) in the protocol DP-P, PA-P, FF-P defined for the field bus DP, PA, FF via the field bus DP, PA, FF for dispatch to a recipient.

The further field bus PA, FF or the devices PA-G, FF-G connected thereto, for which at least two (different) transmission protocols PA-P, FF-P are provided, is operated by the electrical device LNK according to the invention in that it is suitable for addressing not only a device (PA-G) which is connected to the further field bus (PAFF) and can be addressed by means of a first protocol (PA-P), but also a device (FF-G) which is likewise connected to the further field bus (PAFF) and can be addressed by means of a second protocol (FF-P). This specific suitability is achieved for the electrical device LNK according to the invention in that it has at least the communications components PA-M, FF-M, which are in each case suitable communications components on a PA bus or FF bus.

If not only the communications components PA-M, PA-G communicating by means of the first protocol PA-P, but also the communications components FF-M, FF-G communicating by means of the second protocol FF-P are in a master-slave/publisher-subscriber/producer-consumer relationship with one another, whereby the communications component PA-M, FF-M provided in the electrical device LNK in each case performs the role of master/publisher/producer, this produces favorable results in terms of the data throughput from the first field bus DP to the second field bus PAFF.

If, for example, in the applications program APP, a multiplicity of measurement values of a controlled and/or monitored external technical process are presented, whereby at least some of the sensors used to record such measurement values are devices FF-G, PA-G which the profibus DP master M can access only via the electrical device LNK according to the invention, the required communication, in rough outline, runs more or less as follows:

In order to initiate the retrieval of the relevant measurement values, the master M transmits a message which, formulated in natural language, reads roughly as follows:

To [recipient1, recipient2, . . . ]:

Transfer measurements values to [sender], via the profibus DP.

Here, [recipient1, recipient2, . . . ] designates devices which can be contacted via a field bus DP, PAFF. As an example, it is assumed that the devices FF-G, FF-G′ and PA-G, PA-G′ are in each case addressed as at least two devices connected to the field bus PAFF, which can be addressed either by means of the first or by means of the second transmission protocol PA-P, FF-P. Furthermore, [sender] designates the master M which transmits the message and which expects the relevant measurement values in response to the message.

The topology of the communications network is known from special configuration data, and therefore in particular the fact that the addressed devices FF-G, FF-G′ and PA-G, PA-G′ are connected to the field bus PAFF. It is therefore also already clear that the addressed devices FF-G, FF-G′ and PA-G, PA-G′ cannot be contacted directly, but only indirectly via the electrical device LNK. The telegram sent by the master M is therefore initially transmitted to the electrical device, specifically to the DP slave DP-S.

The received message is evaluated here and, as far as the devices PA-G, PA-G′ which can be contacted by means of the first transmission protocol (PA-P) are concerned, forwarded in a suitable manner to the communications component PA-M contained in the electrical device LNK, and, as far as the devices FF-G, FF-G′ which can be contacted by means of the second transmission protocol (FF-P) are concerned, forwarded in a suitable manner to the communications component FF-M contained in the electrical device LNK.

Neither the communications component PA-M nor the communications component FF-M, in which the message has meanwhile been received, are the actual recipients of the message. The received messages are therefore analyzed once more and dispatched to the relevant (final) recipients PA-G, PA-G′ or FF-G, FF-G′, whereby a transfer into the transmission protocol FF-P, PA-P defined for the further field bus PAFF now takes place for the purpose of further dispatch.

In this way, the message originally transmitted by the master M finally reaches the actual addressees PA-G, PA-G′, FF-G, FF-G′.

These then transmit a reply telegram which, formulated in natural language, reads roughly as follows:

To [recipient]: [measurement value].

Here, [recipient] designates the profibus DP master M and [measurement value] the respective recorded measurement value.

Configuration data again reveals that the message, in order to reach the master M, must be routed via the electrical device LNK.

The reason for the favorable results in terms of data throughput is that the communications components PA-M, FF-M of the electrical device, in their capacity as master/publisher/producer, whereby these concepts are often used synonymously in the technical literature, “gather in” the required data, in a manner of speaking, in the actual addressed devices PA-G, PA-G′, FF-G, FF-G′, and can then provide the latter, in a manner of speaking, “en bloc” for the master M, because the master M accesses the third communications component DP-S in its capacity as master, and receives the provided data from the latter.

1. An electrical device (LNK) with a first communications interface (K′) and with a first communications component (DP-S) for a communications connection to a first bus (DP), and with a second communications interface (K) and with further communications components (PA-M, FF-M) for a communications connection to a further bus (PAFF), characterized in that the first bus and the further bus are field buses, and that the electrical device (LNK) is provided to address not only a device (PA-G) which is connected to the further field bus (PAFF) and can be addressed by means of a first protocol (PA-P), but also a device (FF-G) which is likewise connected to the further field bus (PAFF) and can be addressed by means of a second protocol (FF-P), whereby the addressing of the first device (PA-G) which can be addressed by means of the first protocol (PA-P) and the addressing of the second device (FF-G) which can be addressed by means of the second protocol (FF-P) are carried out alternately in a time-slice method, and whereby the second communications interface (K) is provided for joint access by the further communications components (PA-M, FF-M) to the further field bus (PAFF) and the respective devices (PA-G, FF-G) connected to the further field bus (PAFF).

2. The electrical device as claimed in claim 1, characterized in that not only the further communications component (PA-M) which communicates by means of the first protocol (PA-P) with the first device (PA-G), but also the further communications component (FF-M) which communicates by means of the second protocol (FF-P) with the second device (FF-G) are in a master-slave/publisher-subscriber/producer-consumer relationship with the relevant associated device (PA-G, FF-G), whereby in each case one of the further communications components (PA-M, FF-M) provided in the electrical device (LNK) performs the role of master/publisher/producer and, in this capacity, requests the data requested by the master (M) from the devices (PA-G, FF-G) connected to the further field bus (PAFF).

3. The electrical device as claimed in claim 1 or 2, characterized in that the electrical device (LNK) is provided for common communication with profibus devices and Fieldbus Foundation devices.
